(19) United States
(12) Patent Application Publication
(10) Pub. No.: US 2017/0029218 A1
(43) Pub. Date: Feb. 2, 2017

(54) DOSING METHOD AND DOSING DEVICE FOR PARTICLES OF BULK MATERIAL

(71) Applicant: ALFONS TSCHRITTER GMBH, Dorfprozelten (DE)

(72) Inventor: Thorsten TSCHRITTER, Stadtprozelten (DE)

(21) Appl. No.: 15/013,778

(22) Filed: Feb. 2, 2016

(30) Foreign Application Priority Data
Feb. 3, 2015 (DE) 10 2015 201 840.7

(51) Int. Cl. B65G 37/00; B65G 27/04; B65G 47/84

(52) U.S. Cl. CPC B65G 37/00; B65G 47/846; B65G 27/04

(57) ABSTRACT

A method for dosing bulk material particles by using a dosing device and a dosing device is provided. A dosing member of the dosing device performs a conveying movement by rotation, in order to dose bulk material particles and proceeding from a bulk material supply of the dosing device convey the same to a bulk material discharge of the dosing device. The dosing member is at least temporarily put into a shaking and/or vibratory movement in operation of the dosing device, in order to reduce an adherence of bulk material particles among each other and achieve a more uniform mass output from the dosing member.

### CROSS-REFERENCE TO RELATED APPLICATION

This application claims priority to German Patent Application No. 10 2015 201 840.7 filed on Feb. 3, 2015, the entirety of which is incorporated by reference herein.

### BACKGROUND

This invention relates to a method for dosing bulk material particles and a dosing device.

In many applications it is necessary to dose bulk materials from a material reservoir. One possibility of making such dosing is known for example from EP 1 495 230 B1. This device includes a housing with a material inlet and a material outlet as well as a receptacle for a rotor as dosing member. Between the shell surface of the rotor and the inner surface of the housing a channel exists, in which bulk materials can be transported from the material inlet to the material outlet by a rotation of the rotor.

Disadvantages of such dosing devices on the one hand include a non-uniform dosage of the bulk material and on the other hand the fact that one or more elastic sealing means, which are in contact with the rotor, are necessary therein. These sealing means are subject to wear, wherein on the one hand the bulk material can be contaminated by abrasion of the sealing means and on the other hand the sealing property of the sealing means is impaired, and with increasing wear the dosing devices can have a decreasing dosing accuracy. Furthermore, it is a disadvantage of the described dosing devices that bulk material can be dosed uniformly only insufficiently. Especially in so-called micro injection molding methods, however, a non-uniform addition of particles present as bulk material can lead to quite considerable fluctuations in the concentration of the additive added and hence to negative consequences for the quality of the injection-molded product.

For the dosage of bulk materials conveying screws furthermore are known as dosing members, which regularly allow a sufficiently uniform dosage, but can only be used in a narrow speed range. In conveying screws the conveying rate of the bulk material to be dosed moreover does not have a linear relationship to the speed of the conveying screw, which makes handling difficult and limits the range of applications.

Furthermore, it has been observed that—largely independent of the dosing member used—especially at low conveying rates and a resulting slow rotary movement of the dosing member the influence of the static friction between the bulk material particles increases and as a result packages of particles adhering to each other instead of individual particles possibly are added. This can also lead to a non-uniform addition and hence undesired fluctuations in concentration.

### SUMMARY

It therefore is the problem underlying the invention to provide an improved method for dosing bulk material particles and an improved dosing device, which permit a more uniform dosage of the bulk material.

This problem is solved both with a dosing method as described herein and with a dosing device as described herein.

According to a first aspect, a method according to the invention for dosing bulk material particles by using a dosing device provides that a dosing member of the dosing device performs a conveying movement by rotation, in order to dose bulk material particles and convey the same to a bulk material discharge of the dosing device proceeding from a bulk material supply of the dosing device, and in operation of the dosing device the dosing member at least temporarily is selectively put into a shaking and/or vibratory movement.

By putting the dosing member into a shaking and/or vibratory movement, an adhesion of individual bulk material particles to each other can be avoided or at least reduced, so that also at low conveying rates and a resulting slow rotary movement of the dosing member non-coherent formations of particles jointly are present at the bulk material discharge and added like an avalanche. Rather, it was found that the additional targeted application of a shaking and/or vibratory movement for example leads to a more uniform filling of the bulk material particles into a dosing channel of the dosing member and to an increase of the packing density of the bulk material particles at or in the dosing member. In addition, in particular in dosing devices in which the bulk material particles are added to a bulk material discharge by means of gravity, putting the dosing member into a shaking and/or vibratory movement can lead to the fact that the static friction and mechanical entanglement of the bulk material particles among each other is greatly reduced. The consequence is that bulk material particles preferably are dumped individually and in doing so no longer or at best very rarely entrain other bulk material particles. As a result, by putting the dosing member into a targeted shaking and/or vibratory movement according to the invention, a distinctly more uniform mass output of bulk material particles from the dosing member can be achieved.

Bulk material here refers to any mixture which is present in a pourable form. The bulk material for example can be plastic granules, lime, wood particles, fertilizers, feedstuffs, tablets, foodstuffs, such as for example cereals, building materials, raw materials or any other bulk material or an arbitrary mixture of various bulk materials. The particle size, i.e. the grain size or unit size, of the bulk material here can be different depending on the bulk material and in particular a mixture also can be composed of particles of different size. For example, bulk material particles with a mean diameter between 0.5 and 2 mm are conveyed, which also can be oblong with mean lengths between 1 and 3 mm. However, it is also possible to dose and convey bulk materials with distinctly different particle sizes, such as for example bulk material in powder form or in distinctly larger dimensions. The use of a dosing method according to the invention can be advantageous for bulk material particles which are used in an injection molding method.

Dosing member is understood to be any component or assembly of a dosing device which by rotating conveys bulk material particles from a bulk material supply to a bulk material discharge and can provide the bulk material particles in predefined quantities at the bulk material discharge. A dosing member for example can comprise a dosing roller, dosing screw or dosing disk. A dosing device according to the invention, as will be explained in detail below, thus in particular can be formed as roller- or screw-type feeder for bulk material particles.

In one design variant, the dosing member is put into a shaking and/or vibratory movement during a conveying movement. In other words, during the conveyance of the bulk material particles in direction of the bulk material discharge a shaking and/or vibratory movement is superimposed on a rotary movement of the dosing member. When using an individual actuating drive for shifting the dosing member reference also can be made to the fact that a shaking and/or vibratory movement is modulated onto the rotary movement of the dosing member.

In one possible design variant, the dosing member is put into a shaking and/or vibratory movement for the entire duration of a conveying movement. For example, this means that with a discontinuous addition of bulk material particles, in which the dosing member is at rest and is not rotated between two dosing cycles, the dosing member always is put into a shaking and/or vibratory movement, as soon as the dosing member rotates (again), in order to convey bulk material particles. Alternatively or in addition it can be provided that the application of a shaking and/or vibratory movement only is effected for a specified time interval and/or in a predefined range of angles of rotation during the conveying movement of the dosing member, for example only at the beginning and/or at the end or only in a (middle) time window after the start and before the end of the conveying movement. Moreover, putting the dosing member into an additional shaking and/or vibratory movement only can be effected at each second or third dosing cycle. In this way, a greater variability can be achieved and energy possibly can be saved.

According to a second aspect of the invention there is provided a method for dosing bulk material particles by using a dosing device, in which the dosing member is rotated in a first direction of rotation with a first rotational speed for conveying bulk material particles to the bulk material discharge, and before the beginning and/or after the end of a conveying movement the dosing member performs a backward movement by rotating in an opposite second direction of rotation with a second rotational speed different from the first rotational speed. Instead of continuously rotating the dosing member in one direction of rotation, the dosing member here consequently only is oscillated.

In one variant, the first rotational speed with which bulk material particles are transported to the bulk material discharge by the dosing member is smaller than the second rotational speed with which the dosing member is turned back. Preferably the dosing member, for example in the form of a dosing roller, is turned back with relatively high speed. The dosing member so to speak slips through below the bulk particles provided at the bulk material supply. Thereafter, the dosing member is again turned forwards, i.e. in direction of the bulk material discharge, with at least the same angle of rotation, but slightly more slowly, so that bulk material particles are transported. The rotational speed provided for the transport of the bulk material particles for example is smaller by at least 25% as compared to the rotational speed with which the dosing member is turned back. In one design variant the ratio of first to second rotational speed is about 1:2, i.e. the rotational speed provided for the transport is about 50% of the rotational speed with which the dosing member is turned back. The material quantity to be dosed can be controlled via the number of strokes per time unit, the traveling speeds of the dosing member and the angle of rotation.

In one exemplary embodiment, the inventive solution according to the second aspect of the invention utilizes only a fraction, e.g. about ⅔, of a shell surface of the dosing member for the transport of the bulk material particles. The part of the shell surface not utilized for the transport for example can be provided with a drain channel through which bulk material can be drained in a simple and also automated way.

Furthermore, it can be provided that before the beginning and/or after the end of a conveying movement the dosing member is put into a shaking and/or vibratory movement. It can thereby be achieved, for example, that bulk material particles already present at or in the dosing member are more uniformly compacted before the beginning or after the end of a dosing cycle. By means of a more uniform compaction, the supply of bulk material particles to the dosing member for example can be facilitated for a succeeding conveying movement and/or a possible entanglement between individual bulk material particles can be released already. Accordingly, what is also conceivable is a variant in which in operation of the dosing device the dosing member is put into a shaking and/or vibratory movement merely before the beginning and/or after the end of a conveying movement, but during the conveying movement merely a uniform rotation of the dosing member is performed, in order to dose the bulk material particles.

In one exemplary embodiment, the dosing member is turned back before the beginning and/or after the end of a conveying movement, in particular in order to avoid in the case of a shaking and/or vibratory movement of the dosing member that bulk material particles present already in the region of the bulk material discharge are inadvertently dosed in by the oscillating and/or vibrating dosing member. While the dosing member hence is rotated in a first direction of rotation for conveying bulk material particles to the bulk material discharge, it here performs a backward movement before the beginning and/or after the end of a conveying movement by rotating in an opposite second direction of rotation. This backward movement preferably is performed for a predefined time period and/or a predefined angle of rotation or by a specified number of steps when using a step motor as part of a drive for rotating the dosing member.

For example, the dosing member also can be put into a shaking and/or vibratory movement only after the end of the backward movement and hence after stopping of the dosing member. By applying a shaking and/or vibratory movement only after the end of the backward movement, it can be ensured in a comparatively simple way that bulk material particles present at or in the dosing member are compacted and a possible adherence of the bulk material particles to each other is reduced, but that due to the shaking and/or vibratory movement bulk material particles which had been conveyed already almost down to the bulk material discharge by the dosing member do not inadvertently get into the bulk material discharge.

Of course, the dosing member cannot be put into a shaking and/or vibratory movement (only) after the end of a backward movement and after stopping of the dosing member, but (also) at least temporarily during the backward movement or for the entire duration of the backward movement.

With the end of a dosing cycle or at the beginning of a new dosing cycle, the dosing member can be turned back into a starting position which the dosing member has taken after the end of the conveying movement. In the first-mentioned variant, the dosing member hence takes a starting position for the new dosing cycle after the backward movement, so that the dosing member initially must bridge the angle of rotation covered by the backward movement, before new bulk material particles can be conveyed to the bulk material discharge. In the other variant mentioned, a dosing cycle ends with the dosing member being set back by rotation in the first direction of rotation, so that the dosing member again is present in the starting position which it had taken after the end of the conveying movement. The starting position before the backward movement and the starting position for the succeeding dosing cycle hence should be identical. The dosing member thus initially is stopped at the end of a conveying movement, then performs a backward movement and subsequently again a forward movement, in order to take a starting position for a new dosing cycle.

In one exemplary embodiment, the dosing member in operation of the dosing device is put into shaking and/or vibratory movements of different strength. For example, during a conveying movement the dosing member is put into a stronger shaking and/or vibratory movement than during or after a backward movement at the end of a dosing cycle. Different strengths of a shaking and/or vibratory movement for example can be characterized by different amplitude levels, oscillation widths and/or oscillation frequencies.

In one design variant, the dosing member is put into shaking and/or vibratory movements of different strength during a conveying movement. During the rotation of the dosing member a shaking and/or vibratory movement with variable amplitude thus for example is superimposed on the rotary movement. By a strong vibration at the beginning of the conveying movement, the static friction between the individual bulk material particles can be released. By the slighter vibration at the end of a conveying movement and hence towards the end of a dosing cycle it can be achieved on the other hand that the risk for an uncontrolled addition of bulk material particles as a result of shaking and/or vibrating is reduced.

Alternatively or in addition, during a conveying movement the dosing member can be put into a shaking and/or vibratory movement of a first strength and during a backward movement and/or after the end of a backward movement it can be put into at least one shaking and/or vibratory movement of a second strength different from the first strength.

In principle, putting the dosing member into a shaking and/or vibratory movement can be effected by a separate actuating drive which is formed and provided in addition to an actuating drive for the rotation of the dosing member. In one variant, on the other hand, a shaking and/or vibratory movement due to an oscillating rotary movement of the dosing member is generated by the actuating drive also provided for the rotation of the dosing member. Thus, a uniform rotary movement here selectively is superimposed with changes in direction and/or speed, in order to thereby generate a shaking and/or vibratory movement.

According to another aspect of the present invention, there is proposed a dosing device for bulk material particles, in particular for carrying out a method according to the invention, which includes a dosing member dosing the bulk material particles, wherein the dosing member performs a conveying movement by rotation, in order to dose bulk material particles and proceeding from a bulk material supply of the dosing device convey said bulk material particles to a bulk material discharge of the dosing device. According to the invention, the dosing device includes at least one power-operated actuating drive, by means of which
in operation of the dosing device the dosing member at least temporarily is selectively put into a shaking and/or vibratory movement, and/or
for conveying bulk material particles to the bulk material discharge the dosing member is rotated in a first direction of rotation with a first rotational speed, and before the beginning and/or after the end of a conveying movement the dosing member is rotated in an opposite second direction of rotation with a second rotational speed different from the first rotational speed.

The advantages and features explained above in connection with design variants for a method according to the invention thus also apply for design variants of a dosing device according to the invention and vice versa. For example, the actuating drive of a dosing device according to the invention can be coupled with an electronic control unit which actuates the actuating drive such that a method according to the invention is carried out therewith.

Preferably, the dosing member is rotatable by means of the actuating drive for carrying out the conveying movement and the actuating drive in addition is formed and provided to superimpose the conveying movement with a shaking and/or vibratory movement due to an oscillating rotary movement.

As already explained above, the rotatable dosing member for example can comprise a dosing roller, dosing screw or dosing disk. Particularly advantageously, such dosing roller, dosing screw or dosing disk comprises a bulk material channel for transporting the bulk material particles. Such bulk material channel then serves for receiving and transporting bulk material particles. According to an advantageous development, bulk material pockets are provided in the bulk material channel for receiving and transporting the bulk material particles. Preferably, these bulk material pockets are formed trough-shaped with a round/oval/elliptical opening, but shapes different therefrom also are conceivable. The bulk material pockets also serve for receiving and transporting the bulk material particles. Bulk material particles can fall into the bulk material pockets at the bulk material supply and be entrained by said pockets in a rotary movement. Bulk material particles which are received by such bulk material pocket, but are larger than the bulk material pocket, can entrain other surrounding bulk material particles into the rotary movement.

One design variant of a dosing device according to the invention can be equipped with a dosing roller dosing the bulk material particles, which has an upper dead center and a lower dead center, which are defined by the upper and the lower point of intersection of a vertical axis through the axis of rotation of one direction of rotation of the dosing roller with a shell surface of the dosing roller.

It here is provided that the supply of the bulk material particles through an opening of a bulk material supply is effected after the upper dead center in direction of rotation of the dosing roller, and the discharge of the bulk material particles is effected through an opening of a bulk material discharge after the lower dead center in direction of rotation of the dosing roller.

By such an arrangement it is achieved that the bulk material particles can be transported uniformly and carefully by a rotation of the dosing roller in the direction of rotation from the bulk material supply to the bulk material discharge. By activation and/or the speed of the rotation the bulk material is dosed. The conveying rate can have a linear relationship to the rotational speed of the dosing roller. One embodiment of the dosing device can be operated with rotational speeds over an adjusting range of 1:1000, whereby the dosing device is particularly versatile and flexible in use.

The supply/discharge of the bulk material particles is defined by the corresponding openings through which the bulk material particles impinge on the dosing roller or move away from the dosing roller. This also means that remaining parts of the bulk material supply and the bulk material discharge can extend up to before the corresponding dead centers.

The exact arrangement of the bulk material supply and the bulk material discharge (including the corresponding openings) is not defined here in detail. Preferably, however, the supply is in a position shortly before 12 o'clock, in case the dosing roller rotates in anti-clockwise direction.

In principle, the bulk material discharge—in the properly erected condition of the dosing device—can extend parallel to the vertical axis, corresponding to the vertical falling direction of the bulk material particles at the bulk material discharge. However, other configurations also are conceivable; for example, the bulk material discharge can extend obliquely, in order to guide the bulk material particles to a particular place. For discharging the bulk material particles it can be advantageous when the inner surface of the housing has a cylindrical shape and the inner surface of the bulk material discharge located at the front in direction of rotation substantially tangentially meets with the inner surface of the housing.

### BRIEF DESCRIPTION OF THE DRAWINGS

Further advantages and features of the present invention will become apparent from the succeeding description of exemplary embodiments with reference to the Figures.

FIG. 1A shows a first exemplary embodiment of a dosing device according to the invention in a top view along the axis of rotation of a dosing member formed as dosing roller.

FIG. 1B shows a side view of the dosing roller.

FIG. 1C shows the dosing device of FIG. 1A with bulk material particles to be dosed.

FIG. 2 shows a path-time diagram for illustrating the course of dosing cycles known from the prior art under a uniform rotary movement of a dosing member.

FIG. 3 shows a path-time diagram for illustrating a first design variant of a method according to the invention, in which an oscillation of the speed is modulated onto a rotary movement of the dosing member for dosing bulk material particles, in order to put the dosing member into a shaking and/or vibratory movement.

FIG. 4 shows a path-time diagram for a further design variant in which during a conveying movement the dosing member is put into shaking and/or vibratory movements of different strength.

FIG. 5A shows a path-time diagram of a further design variant in which at the beginning of a dosing cycle the dosing member performs a backward movement and in the process is put into a shaking and/or vibratory movement.

FIG. 5B shows a path-time diagram for a development on the basis of FIG. 5A, in which at the beginning of a dosing cycle the dosing member is put into a stronger shaking and/or vibratory movement than during the succeeding conveying movement.

FIG. 6 shows a path-time diagram for a further design variant in which after the end of a dosing cycle the dosing member performs a backward movement and subsequently is put into a shaking and/or vibratory movement.

FIG. 7A shows a further exemplary embodiment of a dosing device according to the invention in a top view along the axis of rotation of a dosing member formed as dosing roller with a drain channel formed therein in a dosing position.

FIG. 7B shows the dosing device of FIG. 7A with the dosing roller in a drain position.

### DETAILED DESCRIPTION

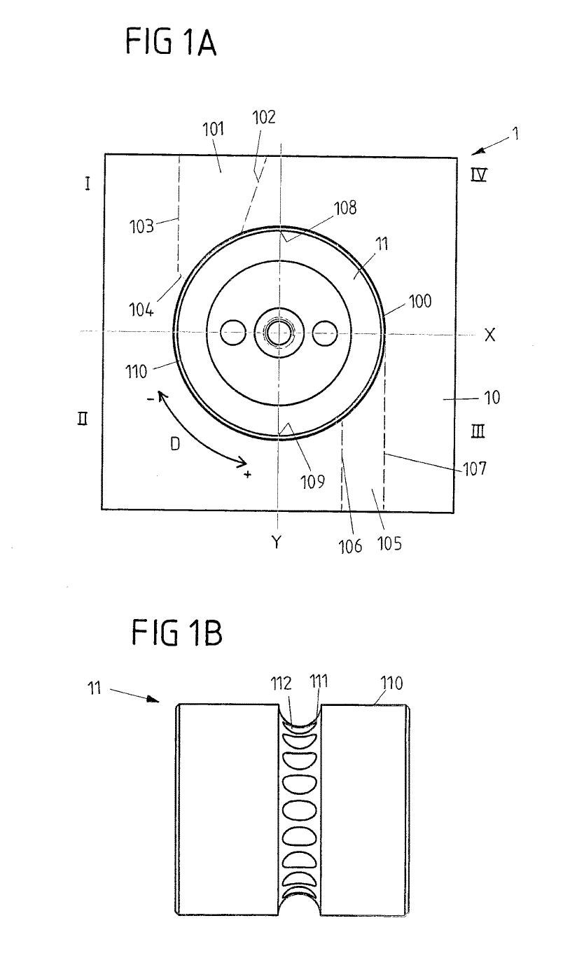

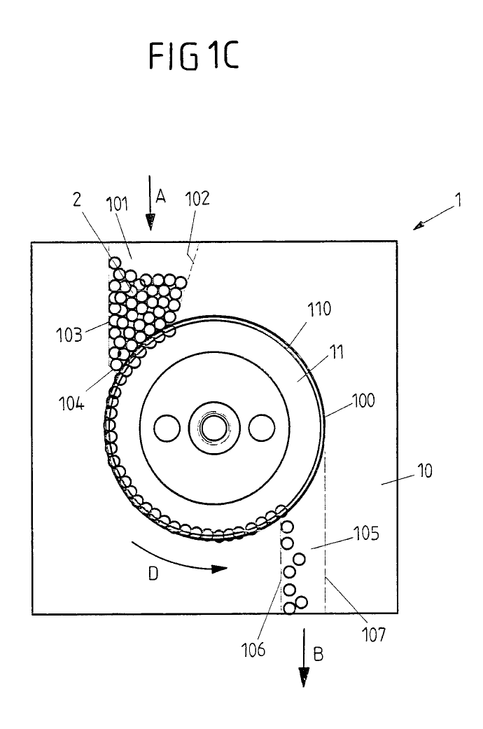

FIG. 1A shows a dosing device 1 in a top view along the rotational axis of the axis of rotation D+ of the dosing roller 11. The dosing roller 11 is arranged and rotatably mounted in a cutout provided for this purpose in the housing 10. It is designed such that between the shell surface 110 of the dosing roller 11 and the inner surface 100 of the housing 10 a uniform gap exists. Since the dosing roller 11 is mounted with a gap, bulk material particles 2 of different size can be conveyed and dosed uniformly and carefully, without the bulk material particles 2 being jammed in the dosing device 1. The width of the gap is chosen such that bulk material particles 2 cannot get into the same. In a substantially cylindrically shaped dosing roller lithe rotational axis of the axis of rotation D of the dosing roller 11 preferably is identical with the cylinder axis of the dosing roller 11.

As can be seen in FIG. 1A, the dosing roller 11 is cylindrical in shape and inserted into a cylindrical recess (bore) of the housing 10. As no scrapers engage into the bulk material channel 111, the dosing roller 11 is easy to remove and to insert again.

The bulk material to be dosed is supplied to the dosing roller 11 via the bulk material supply 101. The bulk material supply 101 can be connected e.g. to a bulk material reservoir or to another supply device. In FIG. 1A, the bulk material supply 101 is shown as a funnel-shaped recess in the housing 10. The bulk material supply 101 is defined by a rear and a front inner surface 102, 103 as seen in direction of rotation D+. The rear inner surface 102 prevents that bulk material particles 2 fall or are pushed through the dosing device 1 against the direction of rotation. Between the inner surfaces 102, 103 an opening extends, through which the bulk material particles 2 impinge on the dosing roller 11. The transport of the bulk material particles 2 through the bulk material supply 101 is effected by means of gravity.

In the embodiment of the dosing device 1, the front inner surface 103 of the bulk material supply 101 as seen in direction of rotation D+ has an edge 104 which substantially vertically meets with the shell surface 110 of the dosing roller 11. By an edge 104 of such shape dosing of the bulk material particles 2 can be effected uniformly; jamming of bulk material particles 2 between the dosing roller 11 and the inner surface 100 of the housing 10 is reduced.

As will be explained in detail with reference to the following FIG. 1B, a bulk material channel 111 for receiving bulk material particles 2 is integrally molded in the shell surface 110 of the dosing roller 11, into which channel the bulk material particles 2 are supplied at the bulk material supply 101. By the rotary movement of the dosing roller 11 in direction of rotation D, the bulk material particles 2 are conveyed in direction of rotation D+. From the bulk material supply 101 down to the lower dead center 109 loosening of the bulk material particles 2 occurs by action of gravity. From the lower dead center 109 to the bulk material discharge 105 the bulk material particles 2 are conveyed against gravity due to the rotation of the dosing roller 11.

In FIG. 1A, the bulk material discharge 105 similar to the bulk material supply 101 is shown as a recess in the housing 10 of the dosing device 1. The housing 10 can consist of a single part or be composed of a plurality of parts. The rear and front inner surfaces 106, 107 of the bulk material discharge 105 as seen in direction of rotation D+ are formed substantially parallel to each other and substantially parallel to the vertical axis Y. The discharge of the bulk material particles 2 is effected through an opening extending between the inner surfaces 106, 107 of the bulk material discharge 105. Through this opening, bulk material particles 2 can exit from the bulk material discharge 105 and from the dosing device 1, for example due to gravity.

In one embodiment of the dosing device 1 the supply of the bulk material particles 2 (through the opening of the bulk material supply 101) is effected after the upper dead center 108 in direction of rotation D+ of the dosing roller 11, while the discharge of the bulk material particles 2 (through the opening of the bulk material discharge 105) is effected after the lower dead center 109 in direction of rotation D+ of the dosing roller 11. The openings shown in FIG. 1A are located at corresponding positions. However, the exact arrangement of the openings is arbitrary, as long as it satisfies the aforementioned requirements. The openings also can be designed broader or narrower than shown in FIG. 1A or be provided at a smaller or greater distance (in direction of rotation D+) to the corresponding dead centers 108, 109.

The inner surfaces of the bulk material supply 101 and the bulk material discharge 105—what is meant here are the surfaces 102, 102, 106 107 shown in FIG. 1A and the surfaces spaced along the rotational axis of the direction of rotation D, which are not shown in FIG. 1A—for example can be formed as planar surfaces and thus form a shaft which has a rectangular cross-section (in the horizontal plane). Likewise, however, said surfaces also can be bent, so that for example a circular or oval cross-section of the bulk material supply 101 and the bulk material discharge 105 is obtained in the horizontal plane. The inner surfaces of the bulk material supply 101 and the bulk material discharge 105 spaced along the rotational axis of the direction of rotation D, which are not shown in FIG. 1A, in particular can be designed such that the bulk material particles 2 are guided only to that part of the shell surface 110 of the dosing roller 11 at which the bulk material channel 111 is integrally molded.

The bulk material channel 111 of the dosing roller 11 is shown in an exemplary embodiment in FIG. 1B. FIG. 1B shows the dosing roller 11 in a first, cylindrical embodiment in a lateral view, i.e. in a viewing direction vertical to the cylinder axis of the dosing roller 11. The illustrated dosing roller 11 includes a bulk material channel 111 extending around the shell surface 110, in which bulk material pockets 112 are integrally molded at regular distances. The bulk material pockets 112 serve for receiving and transporting bulk material particles 2. The size of the bulk material pockets 112 can be adapted to the maximum or average size of the bulk material particles 2 to be transported. It furthermore is possible that the bulk material pockets 112 are provided in various sizes.

The bulk material pockets 112 shown in FIG. 1B are designed trough-shaped, but any modifications of this shape are conceivable, as long as the bulk material pockets 112 are suitable for receiving and/or for transporting the bulk material particles 2. It is not absolutely necessary either that the bulk material pockets 112 are provided in the bulk material channel 111 at regular distances. It is also possible that the distances between bulk material pockets 112 vary. Furthermore, it is conceivable that bulk material pockets 112 are not provided at the entire bulk material channel 111, i.e. over the entire circumference of the shell surface 110 of the dosing roller 11. Depending on the type of bulk material and in case the friction between the bulk material and the bulk material channel 111 is large enough, so that the bulk material particles 2 are entrained in direction of rotation D of the dosing roller 11, bulk material pockets 112 also can be omitted completely, or merely one bulk material pocket 112 can be provided in the bulk material channel 111. Instead of bulk material pockets 112, nubs possibly can also be provided at the bulk material channel 111. Correspondingly, transverse ribs can also be provided at the bulk material channel 111.

The bulk material channel 111 and/or the bulk material pockets 112 can be incorporated into the dosing roller 11, e.g. by milling, or be molded together with the dosing roller, e.g. by injection molding.

Depending on the type of the bulk material to be transported, the bulk material channel 111 can be narrower or broader than the bulk material channel 111 in FIGS. 1B and 1n particular comprise several circumferential rows of bulk material pockets 112.

FIG. 1C shows the dosing device 1 of FIG. 1A with bulk material particles 2 to be transported. In the bulk material supply 101 a reservoir of bulk material particles 2 is located, which are supplied to the dosing device 1 via a bulk material inlet A. A bulk material inlet A can be effected manually or by any suitable device. The bulk material particles 2 get through the opening 108 into the bulk material channel 111 and into the bulk material pockets 112. By the rotation of the dosing roller 11 in direction of rotation D, the bulk material particles 2 are entrained and transported in direction of the bulk material discharge 105. To prevent jamming of bulk material particles 2 in the dosing device 1, the front inner surface 103 as seen in direction of rotation D is provided with an edge 104 which substantially vertically meets with the dosing roller 11.

On their way from the lower dead center 109 to the bulk material discharge 105 the bulk material particles 2 are conveyed against gravity due to the rotation of the dosing roller 11 in the direction of rotation D+. A uniform distribution of bulk material particles 2 already is achieved thereby without any further measures.

As soon as the bulk material particles 2 reach the bulk material discharge 105, they fall through its opening out of the bulk material discharge 105 of the dosing device 1 due to gravity and are supplied to a bulk material outlet B, via which the bulk material particles 2 can be moved on and/or be processed. By previously loosening the bulk material particles 2 and pushing them together a particularly uniform conveying rate of bulk material particles 2 is achieved by the dosing device 1.

It should be noted that instead of gravity and depending on the type of the bulk material particles 2, a positive pressure for example can also be applied to the bulk material supply 101 or a negative pressure can be applied to the bulk material discharge 105, in order to achieve the transport of the bulk material particles 2. Furthermore, a positive or negative pressure at the bulk material supply 101 and/or at the bulk material discharge 105 can be used to remove bulk material particles 2 electrostatically adhering to the dosing device 1. There can be used in particular pulsed compressed air.

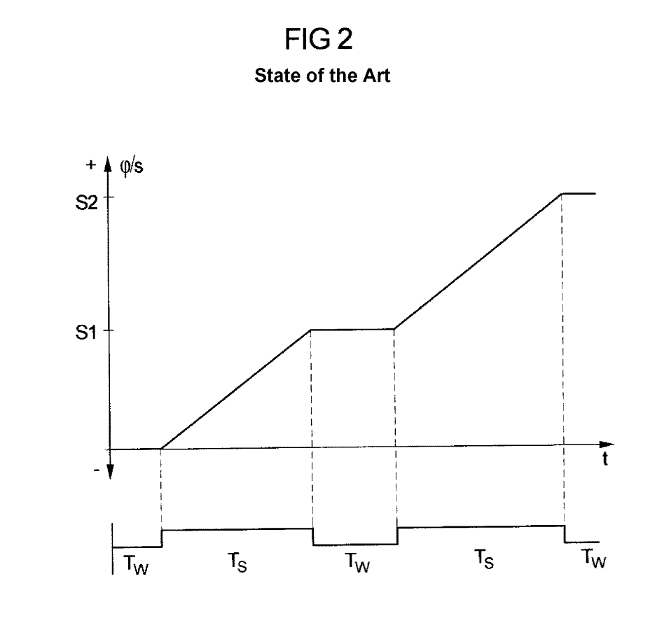

With reference to a path-time diagram FIG. 2 illustrates a commonly used actuation of a rotating dosing member, such as for example of the dosing roller 11 of FIGS. 1A to 1C. On the ordinate an angle (of rotation) φ or the number of steps s of a step motor controlling the rotation of the dosing member is plotted. On the abscissa the time t is plotted.

Corresponding to the diagram of FIG. 2 the dosing member, for example the dosing roller 11 of FIGS. 1A to 1C, initially is at rest for a time interval T_{W} in which no bulk material particles 2 are to be dosed in. Thereafter—for example upon request of a downstream injection molding machine—a conveying movement is triggered. This conveying movement lasts for a defined time interval T_{S}, until the dosing member has been rotated by a specified desired angle or a specified desired number of steps S1. Thereafter, the dosing member stops again for the period T_{W}, before in a succeeding dosing cycle for the time period T_{S} bulk material particles 2 again are conveyed to the bulk material discharge 105 and are dosed in correspondingly (up to the desired angle or the desired number of steps S2).

Although with the illustrated dosing device 1 a comparatively very uniform addition of bulk material particles 2 already is possible when the dosing member in the form of the rotatable dosing roller 11 is rotated in the direction of rotation D+, it was found that especially with slow rotary movements of the dosing roller 11—but also with differently designed dosing members—the influence of the static friction between the bulk material particles 2 is greatly increasing. This can lead to a non-uniform dumping of granules. Instead of individual bulk material particles 2, coherent formations of bulk material particles 2 perhaps are dumped, possibly even like an avalanche. This of course involves fluctuations in the concentration of the dosed additive.

In a dosing method according to the invention, the dosing member now at least temporarily is selectively put into a shaking and/or vibratory movement in operation of the dosing device. In the design variants illustrated below with reference to path-time diagrams a uniform rotary movement of the dosing member selectively is superimposed with changes in direction and/or speed, in order to apply a shaking and/or vibratory movement. For example, an oscillating and/or vibratory movement is modulated onto the rotary movement of the dosing roller or dosing screw as dosing member.

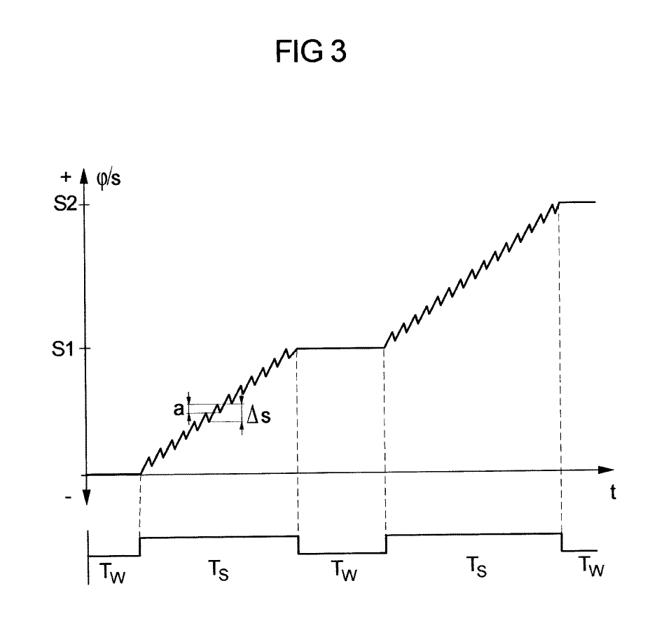

Corresponding to the path-time diagram shown in FIG. 3, the rotary movement for example is superimposed with a shaking and/or vibratory movement for the entire duration T_{S} of a conveying movement of the dosing member. At an amplitude of 1° to 5° and/or a frequency of less than 5 Hz reference for example would be made to a shaking movement and at an amplitude of 0.1° to 2° and a frequency of greater than 5 Hz reference would be made to a vibratory movement. At a shaking movement, bulk material particles 2 at least temporarily are released from the transporting surface of the dosing roller 11. The bulk material briefly behaves like a fluid. Entanglements are released and the bulk material is newly compacted. By a shaking movement, bridges and entanglements between the bulk particles 2 hence can be eliminated. This was found to be advantageous in particular in the case of greatly differing particle shapes and particle sizes, in order to improve the dosing operation. At a vibratory movement, bulk material particles 2 do not completely separate from each other or from the transporting surface of the dosing roller 11, but rather slip and slide along the same due to a decrease in static friction. In particular cavities between the bulk material particles 2 can be closed herewith effectively, whereby a homogenization of the packing density in the bulk channel 111 can be achieved.

Corresponding to the representation in FIG. 3, an oscillating movement with a constant amplitude a and a constant oscillation width Δs is modulated on during the conveying movement of the dosing member. A distinctly more uniform mass output from the dosing member can be achieved thereby, as for example effects of static friction (so-called slip-stick effects) between the bulk material particles 2 are minimized.

For example, acting upon a dosing roller 11 corresponding to FIGS. 1A to 1C along the direction of rotation D+ has different effects. In this connection reference will again be made to FIG. 1A, in which four different quadrants I to IV are illustrated by the space axes X and Y vertical to each other and crossing each other in the point of rotation of the dosing roller 11. In the sectional view of FIG. 1A the four quadrants I to IV divide the dosing roller 11 into four segments of equal size. The quadrant I comprises the region of the dosing roller 11 at which bulk material particles 2 are filled into the bulk material channel 111 via the bulk material supply 101. In the quadrant II adjoining thereto in direction of rotation D+ and hence in anti-clockwise direction, the bulk material particles 2 are transported by the dosing roller 11 in direction of the bulk material discharge 105, which lies in quadrant III.

When applying a shaking and/or vibratory movement onto the dosing roller 11 corresponding to the path-time diagram of FIG. 3, different effects now are achieved in the individual quadrants I to IV, which altogether lead to an improved continuous dumping of particles at the bulk material discharge 105. In quadrant I, the bulk material channel 111 is filled more uniformly when filling bulk material particles 2 into the bulk material channel 111. In quadrant II, the bulk material is compacted more uniformly due to the rotary oscillation or vibration. The individual bulk material particles 2 are aligned more strongly in direction of rotation D+ and thus reduce the fraction of cavities. The bulk/packing density in the bulk material channel 111 is increased and rendered more uniform. In quadrant III, the static friction and mechanical entanglement of the bulk material particles 2 among each other likewise is strongly reduced by the additionally applied shaking and/or vibratory movement, so that the bulk material particles 2 are dumped individually to an increased extent and less strongly entrain other bulk material particles 2.

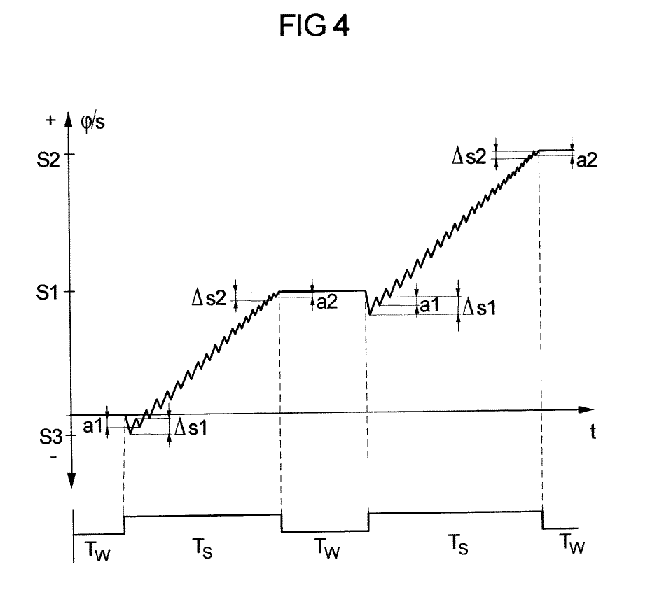

FIG. 4 illustrates a modification of the design variant on the basis of FIG. 3. The linear rotary movement of a dosing member is not superimposed with a uniform and constant oscillation. The intensity of the shaking and/or vibratory movement during the conveyance of bulk material particles 2 rather is varied in its strength. For this purpose, a superposition with an oscillation of variable amplitude a1, a2 is effected. At the beginning of a conveying movement, a rotation of the dosing member is superimposed with a shaking and/or vibratory movement of a first strength, characterized by an amplitude a1 and an oscillation width Δs1. At the end of a conveying movement and hence at the end of a dosing cycle, a shaking and/or vibratory movement of smaller strength is applied, characterized by a smaller oscillation amplitude a2<a1 and smaller oscillation width Δs2<Δs1. For example, the oscillation amplitudes differ by a factor of at least 2, for example by a factor greater than 5. For example, by a strong vibration at the beginning of a conveying movement the static friction between the bulk material particles 2 can be reduced selectively. A weaker vibration at the end of the dosing cycle on the other hand prevents uncontrolled dumping of bulk material particles 2 at the bulk material discharge 105.

To avoid uncontrolled dumping of bulk material particles 2 at the beginning of a conveying movement as a result of the generated shaking and/or vibratory movement, it is additionally provided in the exemplary embodiment of FIG. 4 that the dosing member initially performs a backward movement in an opposite direction of rotation D−. At the beginning of a new dosing cycle the dosing member, for example the dosing roller 11 of FIGS. 1A to 1C, correspondingly is turned back by a specified angle of rotation or a desired number of steps S3, so that bulk material particles 2 initially are removed from the dumping edge of the bulk material discharge 105. The risk that the same already get into the bulk material discharge 105 due to the subsequent shaking and/or vibratory movement at the beginning of the dosing cycle hence is minimized.

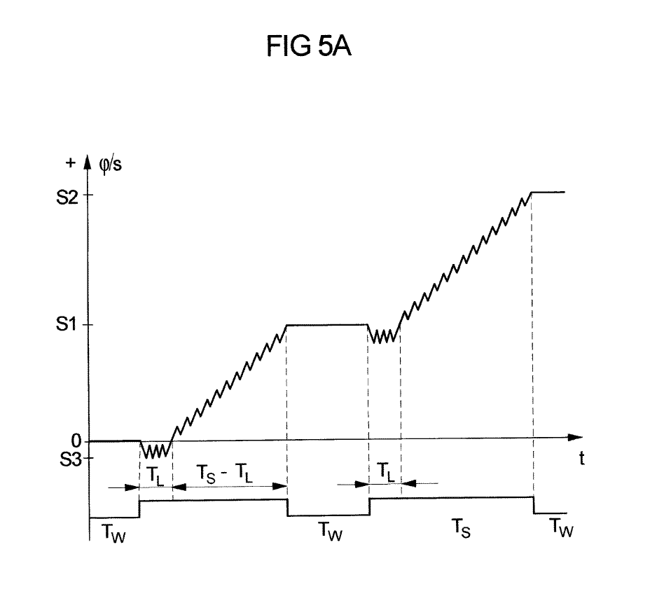

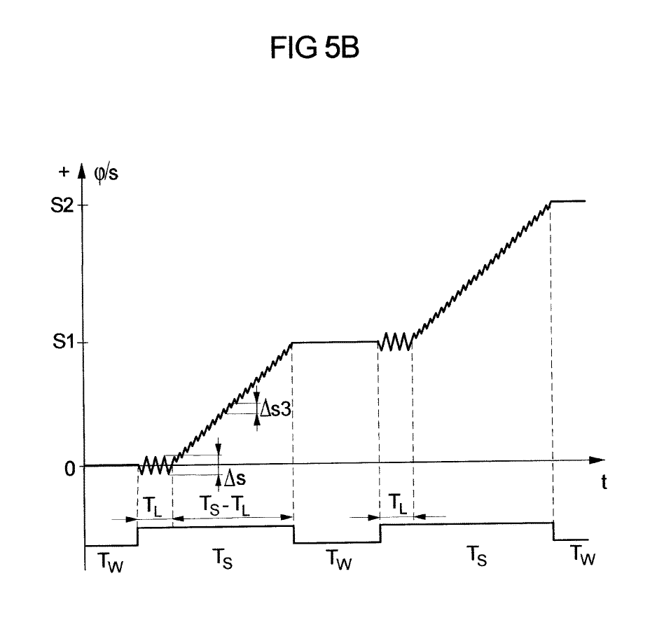

With the path-time diagrams of FIGS. 5A and 5B further design variants of a dosing method according to the invention are illustrated, in which the respective dosing member is put into a shaking and/or vibratory movement not only during a conveying movement, but also in a phase of rest at the beginning of a dosing cycle. It each is provided that over a time interval T_{L} before the beginning of a conveying movement and hence a rotation of the dosing member for conveying bulk material in direction of the bulk material discharge 105 the dosing member is driven to perform an oscillating rotation. The actual conveying movement thus is preceded by a vibration phase at the beginning of the dosing cycle, in order to release the static friction between the bulk material particles 2 and compact the bulk material in the respective bulk material channel of the dosing member.

In a variant according to FIG. 5A at the beginning of a dosing cycle the dosing member initially is turned back by a specified desired angle of rotation or a desired number of steps S3 opposite to the future direction of rotation D+ (in direction of rotation D−) and subsequently is put into a shaking and/or vibratory movement. Subsequently a rotation into the starting position is effected and the conveying movement is started each in the direction of rotation D+. In principle, a uniform rotary movement can be provided subsequent to the shaking and/or vibration phase at the beginning of the dosing cycle. In a design variant corresponding to FIG. 5A, however, it is provided that also during the subsequent conveying movement the dosing member performs an oscillating rotary movement, in order to also be shaken or vibrated during the further dosing cycle.

In the variant according to the diagram of FIG. 5B no backward movement of the respective dosing member is effected at the beginning of a dosing cycle in the initial time interval T_{L}, but the dosing member is oscillated about the position taken last and hence about the starting position of the new dosing cycle. The initial shaking and/or vibratory movement with an oscillation width Δs is greater than an oscillation width Δs3 during the succeeding conveying movement. A reversal of this ratio of the oscillation widths in the time intervals T_{L} and (T_{S}−T_{L}) and of the associated oscillation amplitudes of course also is possible.

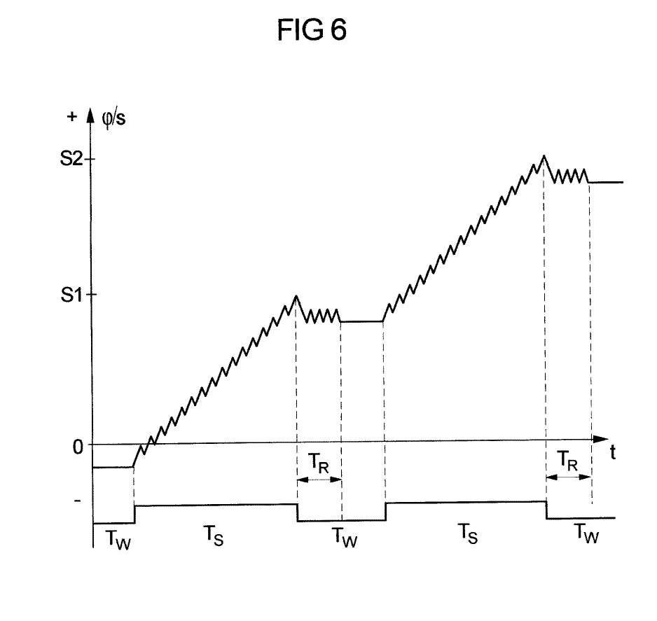

With the path-time diagram of FIG. 6 a further variant of a dosing method according to the invention is illustrated. It here is provided that a dosing member, for example the dosing roller 11 of the dosing device 1 of FIGS. 1A to 1C performs a backward movement at the end of a dosing cycle and on completion of a conveying movement on which a shaking and/or vibratory movement was superimposed.

In the diagram of FIG. 6 this is illustrated by the fact that at the end of a conveying movement lasting over the time interval T_{S} a backward movement is provided at the beginning of a succeeding time interval T_{R}. In the resulting position of the dosing member the same is again driven to perform an oscillating rotary movement during the time interval T_{R} and then remains at rest for the rest of the time interval (T_{W}−T_{R}) between two dosing cycles. Due to the shaking and/or vibratory movement in the period T_{R} after the end of a dosing cycle, the bulk material present at or in the dosing member initially is moved away from the dumping edge and subsequently shaken, in order to in particular achieve an increase of the bulk material or packing density. At the start of a succeeding dosing cycle, the previously covered angle of rotation initially is bridged by the dosing member. This can be accomplished by a uniform rotary movement or by a rotary movement which already is superimposed with a shaking and/or vibratory movement.

As is shown with reference to the attached Figures, it is in particular possible in a method according to the invention to apply a shaking and/or vibratory movement onto a rotating dosing member, such as for example a dosing roller 11, dosing screw or dosing disk, for dosing bulk material particles 2 by targeted changes in direction and/or speed, in order to achieve a more uniform mass output. It can also be provided here to have the dosing member perform a backward movement, in order to move bulk material particles into a region without dumping risk as a result of the shaking and/or vibratory movement, when the actual dosing cycle has already been terminated or has not started yet. In addition, a series connection of various shaking and dosing movements (uniform and/or oscillating) also is possible.

According to a second aspect of the invention the dosing roller 11 also can be operated alternatively or in addition to the above-described shaking and/or vibratory movements such that for conveying bulk material particles 2 to the bulk material discharge 105 in a first direction of rotation D+ rotating is effected with a first rotational speed and before the beginning and/or after the end of a conveying movement the dosing roller 11 performs a backward movement by rotating in the opposite second direction of rotation D− with a second rotational speed larger than the first rotational speed.

In that the dosing roller 11 is turned back with relatively high speed by an angle of rotation φ₂, the dosing roller 11 so to speak slips through below the bulk particles 2 provided at the bulk material supply 101. When the dosing roller 11 subsequently again is turned forwards, i.e. in direction of rotation D+ and in direction of the bulk material discharge 105, with a slower rotational speed by the same or a smaller angle of rotation φ₁, bulk material particles 102 again are transported via the dosing roller 11. The material quantity to be dosed can be controlled via the number of strokes per time unit, the rotational speeds of the dosing roller 11 and the angle of rotation φ₁.

In one variant only a fraction, e.g. about ⅔, of the dosing roller 11 is utilized for the transport of the bulk material particles 2. The part not utilized for the transport for example can be provided with a drain channel through which bulk material can be drained in a simple and also automated way.

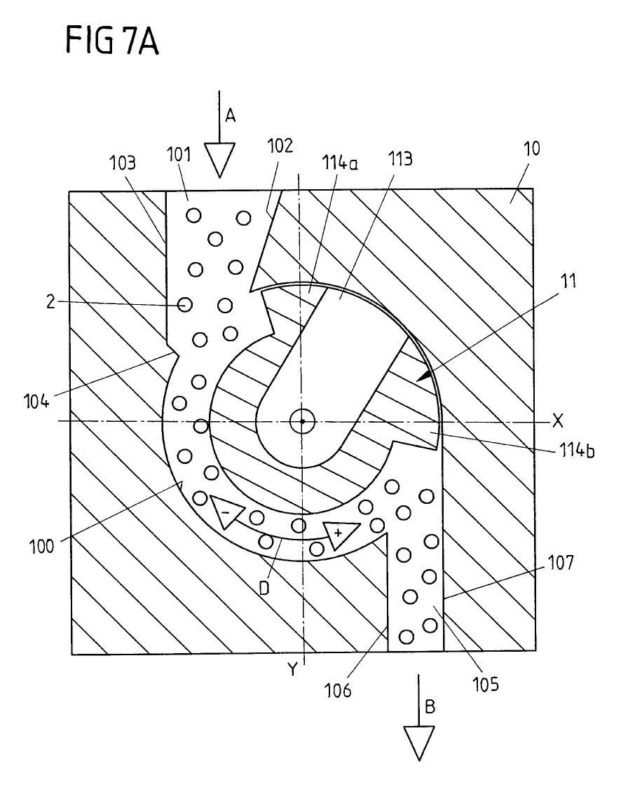

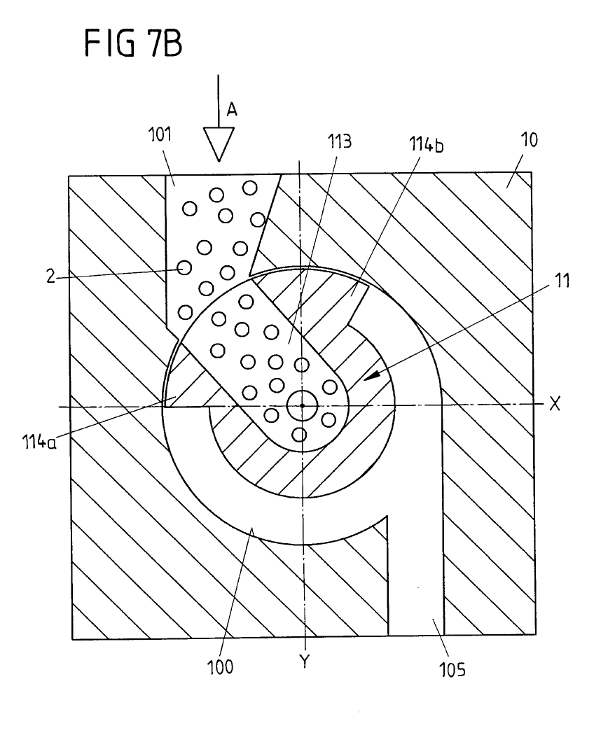

In FIGS. 7A and 7B an exemplary embodiment with such drain channel 113 is illustrated. The dosing roller 11 here includes a drain channel 113 extending radially to the axis of rotation. During a normal dosing operation no bulk material gets into the drain channel 113, as its opening at the dosing roller 11 is bordered by two radially protruding edge portions 114a, 114b of the dosing roller 11, by which the gap between the shell surface of the dosing roller 11 and the inner surface 100 of the housing 10 is reduced to such an extent that no bulk particle 2 can get into the same. Via a protruding edge portion 114b located in direction of rotation D−, the inflow of bulk particles 2 from the bulk material supply 101 in direction of the bulk material discharge 105 is controlled during a dosing operation. The bulk material discharge 105 thereby can be closed and selectively be cleared steplessly or gradually, so that the desired quantity of bulk material particles 2 flows along the shell surface of the dosing roller 11 into the bulk discharge 105. In the position of the dosing roller 11 as shown in FIG. 7A the edge portion 114b completely clears the bulk material discharge 105. At the same time, the edge portion 114a opposed in circumferential direction still is spaced from the bulk material supply 101, so that a maximum possible quantity of bulk particles 2 is dosed in.

When the dosing roller 11 is in a drain position corresponding to FIG. 7B, the opening of the drain channel 113 is brought to congruence with the bulk supply 101. Bulk particles 2 thus can flow from the bulk material supply 101 into the drain channel 113 within the dosing roller 11. The bulk material particles 2 thus received within the dosing roller 11 only can be conveyed from the drain channel 113 to the bulk discharge 105 by rotation of the dosing roller 11 in the direction of rotation D+(anti-clockwise direction). The radially protruding edge portions 114a, 114b here prevent that additional bulk material particles 2 get from the bulk material supply 101 into the bulk material discharge 105.

A dosing method according to the invention and a dosing device according to the invention in particular can be used in a micro injection molding method. There are usually employed very short plasticizing screws which have a substantially worse mixing effect than conventional plasticizing units. One particle (granule) more or less per dosing cycle possibly has large consequences here for the product quality, so that the distinctly more uniform mass output achievable by the present invention and the resulting reduction of fluctuations in concentration are particularly advantageous.

### LIST OF REFERENCE NUMERALS

1 dosing device
10 housing
100 inner surface of the housing
101 bulk material supply
102 rear inner surface of the bulk material supply
103 front inner surface of the bulk material supply
104 vertical edge
105 bulk material discharge
106 rear inner surface of the bulk material discharge
107 front inner surface of the bulk material discharge
108 upper dead center
109 lower dead center
11 dosing roller
110 shell surface of the dosing roller
111 bulk material channel
112 bulk material pockets
113 drain channel
114A, 114b edge portion
2 bulk material particles
X horizontal axis
Y vertical axis
A bulk material inlet
a, a1, a2 amplitude
B bulk material outlet
D direction of rotation of the dosing roller
s distance/steps
S1, S2, S3 desired angle/desired number of steps
t time
T_{L}, T_{R},
T_{S}, T_{W} time interval
φ angle
Δs, Δs1,
Δs2, Δs3,

1. A method for dosing bulk material particles by using a dosing device, wherein a dosing member of the dosing device performs a conveying movement by rotation, in order to dose bulk material particles and proceeding from a bulk material supply of the dosing device convey the same to a bulk material discharge of the dosing device,
wherein in operation of the dosing device the dosing member at least temporarily is selectively put into a shaking and/or vibratory movement.

2. The method according to claim 1, wherein during a conveying movement the dosing member is put into a shaking and/or vibratory movement.

3. The method according to claim 2, wherein the dosing member is put into a shaking and/or vibratory movement for the entire duration of the conveying movement.

4. The method according to claim 1, wherein before the beginning and/or after the end of a conveying movement the dosing member is put into a shaking and/or vibratory movement.

5. A method for dosing bulk material particles by using a dosing device, wherein a dosing member of the dosing device performs a conveying movement by rotation, in order to dose bulk material particles and proceeding from a bulk material supply of the dosing device convey the same to a bulk material discharge of the dosing device,
wherein for conveying bulk material particles to the bulk material discharge the dosing member is rotated in a first direction of rotation with a first rotational speed and before the beginning and/or after the end of a conveying movement the dosing member performs a backward movement by a rotation in an opposite second direction of rotation with a second rotational speed different from the first rotational speed.

6. The method according to claim 5, wherein the first rotational speed is smaller than the second rotational speed, in particular smaller by at least 25%.

7. The method according to claim 5, wherein turning back is effected with the second rotational speed by a second angle of rotation which is at least as large as a first angle of rotation by which the dosing member previously has been rotated with the first rotational speed for conveying bulk material particles.

8. The method according to claim 1, wherein for conveying bulk material particles to the bulk material discharge the dosing member is rotated in a first direction of rotation and before the beginning and/or after the end of a conveying movement the dosing member performs a backward movement by a rotation in an opposite second direction of rotation.

9. The method according to claim 8, wherein after the end of the backward movement the dosing member is put into a shaking and/or vibratory movement.

10. The method according to claim 8, wherein the dosing member is put into a shaking and/or vibratory movement at least temporarily during the backward movement or for the entire duration of the backward movement.

11. The method according to claim 9, wherein at the end of a dosing cycle, during which bulk material particles are conveyed to the bulk material discharge by the conveying movement of the dosing member, the dosing member performs a backward movement in the second direction of rotation and thereby takes a starting position for a new dosing cycle.

12. The method according to claim 9, wherein at the end of a dosing cycle, during which bulk material particles are conveyed to the bulk material discharge by the conveying movement of the dosing member, the dosing member performs a backward movement in the second direction of rotation and subsequently again is shifted in the first direction of rotation, in order to take a starting position for a new dosing cycle.

13. The method according to claim 1, wherein in operation of the dosing device the dosing member is put into shaking and/or vibratory movements of different strength.

14. The method according to claim 13, wherein during a conveying movement the dosing member is put into shaking and/or vibratory movements of different strength.

15. The method according to claim 8, wherein in operation of the dosing device the dosing member is put into shaking and/or vibratory movements of different strength, wherein during a conveying movement the dosing member is put into a shaking and/or vibratory movement of a first strength and during a backward movement and/or after the end of a backward movement the dosing member is put into at least one shaking and/or vibratory movement of a second strength different from the first strength.

16. The method according to claim 1, wherein a shaking and/or vibratory movement is generated by an oscillating rotary movement of the dosing member.

17. A dosing device for bulk material particles with a dosing member dosing the bulk material particles, which performs a conveying movement by rotation, in order to dose bulk material particles and proceeding from a bulk material supply of the dosing device convey the same to a bulk material discharge of the dosing device,
wherein the dosing device includes at least one power-operated actuating drive by means of which at least one of
the dosing member at least temporarily is selectively put into a shaking and/or vibratory movement in operation of the dosing device,
the dosing member for conveying bulk material particles to the bulk material discharge is rotated in a first direction of rotation with a first rotational speed and the dosing member is rotated before the beginning and/or after the end of a conveying movement in an opposite second direction of rotation with a second rotational speed different from the first rotational speed.

18. The dosing device according to claim 17, wherein the dosing member is rotatable by means of the actuating drive for carrying out the conveying movement and the actuating drive in addition is formed and provided to superimpose the conveying movement with a shaking and/or vibratory movement due to an oscillation rotary movement of the dosing member.
